(19) United States
(12) Patent Application Publication
(10) Pub. No.: US 2019/0383608 A1
(43) Pub. Date: Dec. 19, 2019

(54) Method of displaying compass headings

(71) Applicant: Dien Mark Nguyen, Lighthouse Point, FL (US)

(72) Inventor: Dien Mark Nguyen, Lighthouse Point, FL (US)

(21) Appl. No.: 15/868,817

(22) Filed: Jan. 11, 2018

(51) Int. Cl. G01C 17/28; G01S 13/93

(52) U.S. Cl. CPC G01C 17/28; G01S 13/931; G01C 17/38; G01S 13/9303; G01S 13/9307

(57) ABSTRACT

A method of displaying compass headings includes the steps of: assigning specific colors to at least the four primary directional points North, East, South and West of a compass; and emitting the assigned colors from a single light source (e.g., a tri-colored LED) to visually indicate a current compass heading or orientation of a person, object, vehicle or craft (e.g., boat, airplane, helicopter or drone). The method may further include use of coded flashes of one or more colors to indicate compass points while minimizing the number of assigned colors for ease of memorization.

### BACKGROUND OF THE INVENTION

### Field of the Invention

The invention relates to compass heading displays and, more particularly, to a method of displaying compass headings using a spectrum of colors.

### Discussion of the Related Art

The traditional magnetic compass has been the standard for use in navigation. A free-floating needle, disk, or sphere is used to display directional compass data. With the advent of the electronic compass, devices are more portable and accurate. Today's solid-state compass circuits are small, accurate, and inexpensive. However, the graphic or alpha-numeric display contributes significantly to the cost, size, and complexity of the system. Assigning a dedicated LED to each of the compass points (N, S, E, and W) has also been considered, but this requires multiple LEDs (4, 8, or 16), increased size, and wiring complexity.

The compass display method of the invention assigns a specific color emitted by an inexpensive tri-colored LED, coded by flashes for differentiation, to each point of the compass. Once a user has learned to associate the assigned color code to a direction, compass data can now be conveyed to an observer through a single source of light. Compass data, and particularly the heading (i.e., path of travel) of a vehicle/craft, can also be easily and conveniently conveyed from a single light source to a distant observer. This method makes the electronic compass feasible in many new applications.

### SUMMARY OF THE INVENTION

The invention relates to a method of displaying compass directions/headings to an observer. The method of the present invention includes the steps of: assigning specific colors to at least the four primary directional points North, East, South and West of a compass; and emitting the assigned colors from a single light source (e.g., a tri-colored LED) to visually indicate a current compass heading of a person, object, vehicle or craft (e.g., boat, airplane, helicopter or drone). The method may further include assigning specific colors to eight directional points of a compass, sixteen directional points of a compass, and so on. Moreover, the specific colors assigned to the four or more directional points of the compass may be according to a specific sequence such as decreasing wavelength or the rainbow spectrum ROYGBIV (red, orange, yellow, green, blue, indigo and violet). The method may further include the step(s) of flashing the tri-colored LED sequentially between adjacent colors to reduce the number of assigned colors, thereby allowing for easier memorization of assigned compass point colors by the user.

### DETAILED DESCRIPTION OF THE PREFERRED EMBODIMENTS

The method of the present invention provides for the assignment of an emitted colored light to represent each specific compass point. For example, 8 points of a compass (N, NE, E, SE, S, SW, W, NW) can be represented by 8 different color emissions, 16 points with 16 colors, and so on. One technique to help memorize the sequence is to use the decreasing wavelength or rainbow spectrum ROYGBIV (red, orange, yellow, green, blue, indigo, violet). As an example, if the assignment for N is red, then NE is orange, E is yellow, SE is yellow/green, S is green, SW is aqua/blue, W is indigo, NW is violet. With training, one can distinguish between the eight or maybe even 16 different colors. The accuracy or resolution of the system is limited by one's ability to differentiate between the adjacent colors. Another method to help reduce the memorization of many colors is to flash the LED sequentially between the adjacent colors. For example, for an 8-colored compass where N is red, NE is orange, and E is yellow, a certain system is designed to flash its directional color 1 second on and 1 second off. When pointing N, the LED would flash red on for 1 second, then off for the next 1 second. The on/off flashing cycle of red (North) and off remains until the direction changes. Similarly for other colors/directions. To represent NNW, the LED would flash red for a half second, followed by a half second violet flash, then 1 second off; thus, sequential dual color flash. ENE would be orange for a half second, yellow for a half second, and then off for one second. The user now would only need to memorize 8 color positions while having codes to understand the 16 points of the compass.

For background purposes, a tri-colored LED is a single packaged LED which contains three individual primary colored LEDs (one red, one green, one blue). The intensity of each LED can be independently modulated and mixed to create (i.e., emit) any color our eyes see. With all colors at maximum intensity, the color will be white. For higher intensity applications, individual RGB LEDs mounted closely on a panel can been used.

The application of the compass display method of the present invention can also be used to supplement the anti-collision or navigation light system used in aviation, marine, and off-road vehicles. This would allow a distant observer to see an incoming object's trajectory. This additional visual data can help to determine the path of the vehicle/object for collision avoidance. The compass colored light can be flashed or strobed at different rates to differentiate itself from existing navigation lights. For example, on a boat or plane, there are basically three navigation lights: red for left (port) side, green for right (starboard) side, and white for the stern or aft light. The colored compass light can be designed to replace or compliment the stern/aft light. In this instance, the RGB LEDs can be all-on (to represent white spectrum) as the white stern light. Perhaps every few seconds, the device would strobe in a specific color for the direction of travel of the vehicle/craft and then turn back to white. This will allow other pilots in the area to easily and quickly determine the direction of travel of another vehicle/craft.

The compass display method of the present invention can also be incorporated on helicopters, UAVs (unmanned aerial vehicle), or drones. Due to the omnidirectional nature of some drones, traditional aviation navigation lights (left, right, front, and aft) are not applicable. An RGB LED may be the optimal navigation light for drones due to its size and shape. Accelerometers and gyroscopes can be used in conjunction with the compass to signal the direction of travel instead of pointing direction.

The application of the compass display method of the present invention can be applied to portable navigation devices. The simplistic display method can provide significant cost, size, and reliability advantage. A product may have only an optical light window port while the active electronics of the compass can be fully sealed from the harsh environment, such as water and dust. The device's external-facing lens can transmit light to other locations by ways of reflective mirrors, fiber optics, acrylic light rod/pipe, optical gel/glue, or plexi-glass materials. The directional compass display method of the present invention is ideal for swimming googles, scuba diving masks, virtual/augmented reality head-mounted displays, binoculars, smart-glasses, pens, pointers, and also vehicle dashboard displays. The compass colored light can be displayed as a point source from the LED lens or as background lighting. The optical display can be a part of the product casing itself, such as optically clear plexi-glass/plastic, or clear silicone rubber casing.

The compass display method of the present invention can be employed in dashboard applications for any moving vehicles. It can help to de-clutter dashboard of graphics, texts, and numbers by using a glowing colored background to represent the direction of travel.

The directional compass display method of the present invention can also be incorporated in a standalone product such as a “compass puck,” a rounded product with a dome top for the optical LED and a sticky or magnetic bottom. The compass puck (or similar standalone device) is a portable battery-powered electronic compass which you can mount anywhere to give you direction of travel or heading. Its useful applications are open to the creativity of the users. For example, placing several units at various locations on the deck of a sailboat will help the crew to confirm the captain's maneuvering intentions. It can also be mounted on off road vehicles, mountain bicycles, kayaks, etc.

While the present invention has been described in accordance with several preferred embodiments thereof, it is recognized that departures from the instant disclosure are fully contemplated within the spirit and scope of the present invention which is not to be limited except as defined in the following claims as interpreted under the Doctrine of Equivalents.

1. (canceled)

2. (canceled)

3. (canceled)

4. (canceled)

5. (canceled)

6. (canceled)

7. A method of displaying compass headings comprising the steps of:
assigning specific colors to directional points of a compass wherein the directional points are each assigned a different color; and
emitting the assigned colors from a single light source to visually indicate a current compass heading.

8. The method as recited in claim 7 wherein the step of assigning specific colors to directional points of a compass further comprises the step of:
assigning specific colors to at least the four primary directional points North, East, South and West of a compass.

9. The method as recited in claim 7 wherein the step of assigning specific colors to directional points of a compass further comprises the step of:
assigning specific colors to at least eight directional points of a compass including North, Northeast, East, Southeast, South, Southwest, West and Northwest.

10. The method as recited in claim 7 wherein the step of assigning specific colors to directional points of a compass further includes the step of:
assigning the specific colors in sequence according to the color spectrum of red, orange, yellow, green, blue, indigo, and violet.

11. The method as recited in claim 7 further comprising the step of:
emitting coded flashes of one or more of the assigned colors from the single light source to indicate at least some of the directional points of the compass.

12. The method as recited in claim 7 wherein the single light source is a tri-colored LED.

13. A method of displaying compass headings comprising the steps of:
assigning specific colors to directional points of a compass wherein the directional points are each assigned a different color; and
emitting the assigned colors from a multi-colored single light source to visually indicate a current compass heading.

14. The method as recited in claim 13 wherein the step of assigning specific colors to directional points of a compass further includes the step of:
assigning the specific colors in sequence according to the color spectrum of red, orange, yellow, green, blue, indigo, and violet.

15. The method as recited in claim 13 further comprising the step of:
emitting coded flashes of one or more of the assigned colors from the multi-colored single light source to indicate at least some of the directional points of the compass.

16. The method as recited in claim 13 wherein the multi-colored single light source is a tri-colored LED.
